(19) United States
(12) Patent Application Publication
(10) Pub. No.: US 2006/0150327 A1
(43) Pub. Date: Jul. 13, 2006

(54) Supporting spring system for mattresses or the like and use of a supporting spring system of this type

(76) Inventors: Klaus Jansen, Buxtehude (DE); Michael Vent, Apensen (DE)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/292,482

(22) Filed: Dec. 2, 2005

Related U.S. Application Data
(63) Continuation-in-part of application No. 10/490,082, filed on Mar. 18, 2004, now abandoned.

(30) Foreign Application Priority Data
Oct. 1, 2001 (DE) 101 48 569.7

(51) Int. Cl. A47C 23/30; A61G 7/015

(52) U.S. Cl. 5/239; 5/613

(57) ABSTRACT

A supporting spring system designed such that at least individual slats can be individually raised and lowered proximal to bearing means, enabling the supporting spring system to execute any desired movements that are transferred via the mattress to the individual lying on it, thus enabling prevention or treatment of bed sores, stimulating patients with certain clinical characteristics such as patients whose mobility is limited and thus suffer from lack of stimulus, and treatment of pain.

### STATEMENT OF RELATED APPLICATIONS

This application is a continuation in part of U.S. patent application Ser. No. 10/490,082, having a filing date of 18 Mar. 2004, which is the US Chapter II National Phase of Patent Cooperation Treaty International Application No. PCT/EP02/10715, having an International Filing Date of 25 Sep. 2002, which designates the US, and which in turn claims priority on German Patent Application No. 101 48 569.7, having a filing date of 1 Oct. 2001.

### BACKGROUND OF THE INVENTION

1. Technical Field

The invention relates to a supporting spring system for mattresses or the like having slats which support the mattress or the like, and having bearing means which are assigned to opposite ends of the slats and are intended for elastically mounting the slats on a frame. The invention also relates to preferred uses of supporting spring systems of this type.

2. Prior Art

Supporting spring systems that are intended for mattresses or the like of furniture for sleeping on, lying on and/or sitting on and have resilient slats which are mounted elastically on a frame or other fixed objects by means of elastic bearing means are known. These slats run parallel to one another at fixed, usually equal distances apart. It is possible, by changing the elasticity of the bearing means, to adapt the spring properties of the supporting spring system to the needs of an individual lying on the mattress or the like.

Individuals whose perceptive facility is limited or impaired, for example unconscious individuals, individuals whose mobility is severely limited, but also individuals at risk of bed sores and/or individuals suffering from chronic pain are exposed to various problems due to being confined to bed for a long period of time. These problems include, in particular, lack of stimulus, bed sores and pain caused by being in a lying position. Although known supporting spring systems for mattresses or the like can be adapted in their elasticity behaviour to the needs of the particular individual, they cannot or cannot in any case sufficiently solve the problems mentioned above in this way.

### BRIEF SUMMARY OF THE INVENTION

Starting from the above, the object of the invention is to provide supporting spring systems for mattresses, in particular, which make it possible to individually stimulate the individual lying on the mattress, and serve, in particular, for preventing and treating bed sores, for assisting in the treatment of pain and/or for preventing a lack of stimulus.

A supporting spring system for achieving this object has the features of a supporting spring system for mattresses or the like, having slats which support the mattress or the like, and having bearing means which are assigned to opposite ends of the slats and are intended for elastically mounting the slats on a frame, characterized in that at least some of the slats can be moved up and down in a specifically controlled manner. Owing to the fact that at least some slats can be moved up and down in a specifically controlled manner, the supporting spring system according to the invention exerts movements on the underside of the mattress or the like, which are transferred to the individual lying on the mattress. On account of at least some slats being moved up and down in a specifically controlled manner, these slats can be individually raised, lowered and/or tilted. This enables the particular individual, in particular the patient, to be moved individually, specifically in accordance with his needs or requirements. The movements can be exactly proportioned and, if required, kept within narrow limits, which is important for assisting in the treatment of pain.

The slats can preferably be moved up and down at their opposite ends. This movement can be controlled in such a manner that the ends of the particular slat are moved up and down to the same extent (synchronously), so that the slat does not change its inclination. However, if required the ends of at least some slats may also be raised to different extents or one end is raised and the other end is lowered, so that the inclination of the slat concerned changes. Corresponding, individual control of a plurality of slats, a plurality of groups of slats or even all of the slats enables any desired movements to be brought about, specifically undulatory movements, movements on an inclined plane or even a rotation. To this end, at least some slats can be moved up and down by means of lifting elements which are assigned to their opposite ends and are preferably designed in the manner of air springs.

According to one preferred refinement of the invention, the lifting elements are arranged in the regions of the bearing means of the slats, and are preferably assigned to the bearing means. This enables the lifting elements to be accommodated in a space-saving manner at the ends of the slats and, if necessary, to be integrated in the bearing means. It is also possible for the lifting elements in the regions of the bearing means or even in the bearing means to be used to support or override the spring properties of the bearing means.

The lifting elements are preferably designed as bellows-like hollow bodies. These can be moved up and down as desired, in particular in a specifically proportioned manner, with a fluid, it being possible for this to be a liquid or a gas. The hollow bodies are preferably moved up and down with a gas, in the simplest case air, the compressibility of the gas resulting in gentle, jerk-free movements of the individuals.

A further supporting spring system for achieving the object mentioned at the beginning has the features of a supporting spring system for mattresses or the like, having slats which support the mattress or the like, and having bearing means which are assigned to opposite ends of the slats and are intended for elastically mounting the slats on a frame, characterized in that the bearing means have hollow bodies or the hollow bodies are assigned to the bearing means, the hollow bodies being connected to fluid lines for individually feeding the hollow bodies with a fluid and/or for individually conducting the fluid out of the hollow bodies. Owing to the fact that at least some of the hollow bodies or those hollow bodies which are assigned to the slats are connected to fluid lines which can be fed individually with a fluid, each hollow body can, if necessary, be individually and specifically supplied with a fluid and therefore pressurized, and also the pressure in the particular hollow body can be individually reduced. This enables any desired movements of the slats. In particular, the slats or the ends of the slats can obtain sensitive lifting movements, as a result of which the individual lying on the particular mattress can be stimulated in a specific manner. The movements can be controlled in a manner adapted to the clinical characteristics of the particular individual.

The supporting spring system according to the invention is preferably designed in such a manner that the bearing means have spring elements for elastically mounting the ends of the slats, preferably all of the slats, and in addition the hollow bodies which are assigned to at least some slats change the elasticity of the mounting of these slats. Changes of the pressure in the hollow bodies enable the spring properties of the bearing means concerned to be changed in a specifically controlled manner. In addition, those ends of the slats to which hollow bodies are assigned can be moved individually, namely can execute lifting movements directed upward and downward. The hollow bodies are preferably designed in such a manner and assigned to the ends of the slats in such a manner that the lifting movement take place perpendicularly with respect to the longitudinal axis of the slats and therefore perpendicularly with respect to the plane of the mattress or the like. However, in the process the inclination of the mattress can also be changed by the lifting elements at opposite ends of at least one slat being involved to different extents in executing correspondingly controlled lifting movements. Moreover, in addition, specifically controlled lifting movements of the individual hollow bodies make possible changes in the surface of the mattress, specifically also dynamic changes in the surface by the latter following, for example, a continuous undulation and/or rotational movement. To this end, individual hollow bodies, in particular groups of hollow bodies, to which one or more slats are assigned, can be acted upon by different pressures.

To individually change the pressures in the hollow bodies, each hollow body can preferably be fed with a fluid by a dedicated fluid line. The particular fluid line can be supplied with the desired pressure, and also vented, individually via a corresponding fluid supply device and/or a valve unit. The pressure in each desired hollow body can be controlled as required by a control device. The control device can be controlled both manually and also in accordance with predetermined programs. The programs of the control device can be selected with regard to the particular type of stimulation depending on the needs of the person resting in each case on the mattress or the like. In addition, the control device permits certain stimulation patterns, in which the upper side of the mattress is transferred into an undulatory movement, rotational movement, an inclined position or vibrating movements.

The supporting spring systems described above are suitable in particular for treating and preventing bed sores, for promoting perception, for preventing lack of stimulus and/or for assisting in the treatment of pain. The supporting spring systems according to the invention cause a person lying on a mattress, in particular of a bed, to be stimulated. Various basal stimulations are possible here, specifically, for example, somatic, vestibular, vibratory, oral, auditory, tactile and haptic and/or visual stimulations.

### BRIEF DESCRIPTION OF THE DRAWINGS

A preferred exemplary embodiment of the supporting spring system according to the invention is explained in greater detail below with reference to the drawing, in which:

FIG. 1 shows a plan view of a supporting spring system of which part is illustrated in simplified form.

FIG. 2 shows a side view of a bearing means together with a mounting of a lateral end of a slat.

FIG. 3 shows a perspective view of a lifting element in the region of one end of a spring slat together with part of a controlling means.

FIG. 4 shows a side view of a further embodiment of a lifting element with a motor drive.

FIG. 5 shows a top view of a further embodiment of a lifting element with a motor drive.

FIG. 6 shows a side view of a further embodiment of a lifting element with a motor drive,

FIG. 7 shows a side view of a further embodiment of a lifting element with a motor drive, and

FIG. 8 shows a cross-sectional view of a lifting element with a shape memory drive.

### DETAILED DESCRIPTION OF THE PREFERRED EMBODIMENTS

The supporting spring system shown here serves as a support for at least one mattress or other base of a bed, or a piece of furniture for lying on or sitting on.

The supporting spring system has a plurality of elongate slats 10. The slats 10, which are preferably of identical design and in particular of equal length, are spaced apart parallel to one another in the direction transverse to the longitudinal direction 11 of the supporting spring system. The slats 10 are preferably at an equal distance from one another, but may also vary in distance from one another in some regions. The supporting spring system shown here also has two bar elements 12 which (in the present case) are of identical design and run in the longitudinal direction 11 of the supporting spring system, specifically parallel to each other. Elastic bar elements 12 of this type are known, for example, from DE 199 45 724 A1, to which reference is made in full in this respect. The bar elements 12, which are of identical design, are assigned to opposite longitudinal edges of the supporting spring system and bound them. The bar elements 12 are supported on longitudinal struts (not shown) of a bed or of a frame. The slats 10 are connected in opposite end regions to the bar elements 12. The bar elements 12 form elastic bearing means for the ends of the slats 10. The bar elements 12 serve at the same time to hold and to guide the slats 10 at their opposite ends, so that the slats 10 essentially retain their relative arrangement with respect to one another.

The invention is not restricted to the mounting shown here of the slats 10 on elastic bar elements 12. On the contrary, it is also conceivable to assign any other desired bearing means to the ends of the slats 10 and, as a result, to mount the slats 10 in an elastically moveable manner on longitudinal struts of a frame, a bed or the like.

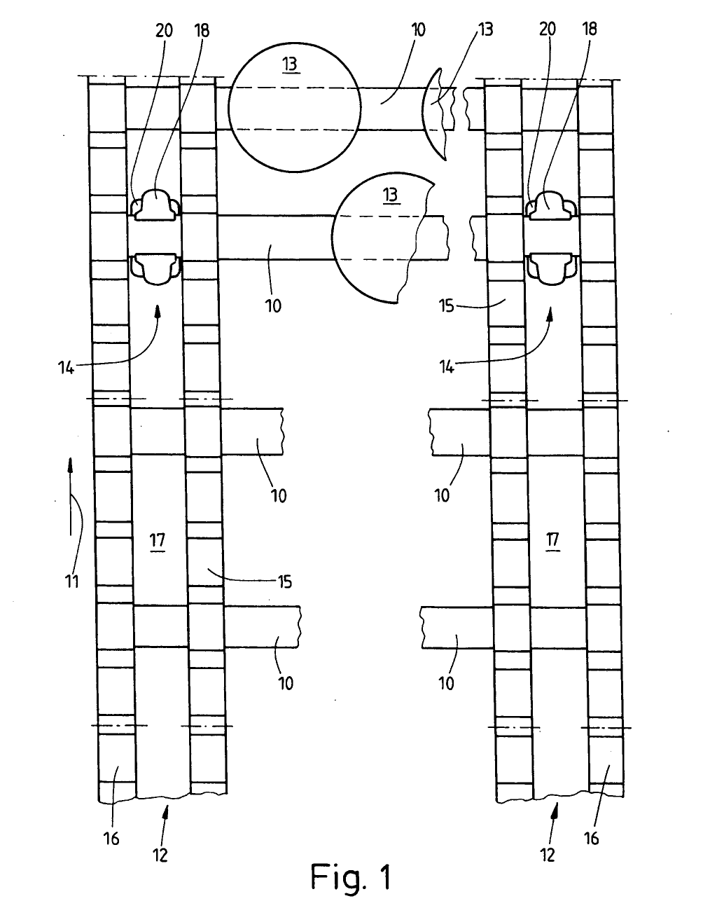

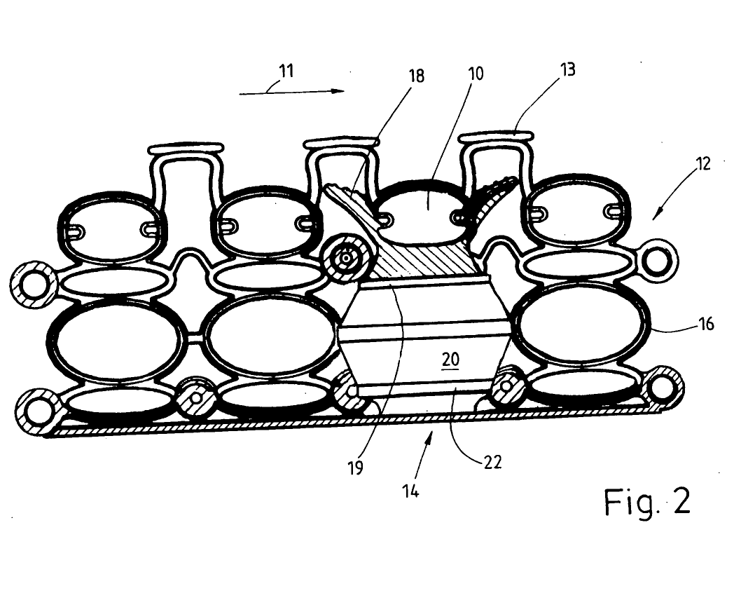

In the exemplary embodiment shown, at least some slats 10 are assigned a plurality of supporting plates 13. One slat 10 may have a plurality of supporting plates 13 which are preferably at uniform distances apart. The supporting plates 13 of adjacent slats 10 are offset in relation to one another in such a manner that the supporting plates 13 of adjacent slats 10 are staggered with respect to one another (FIG. 1).

According to the invention, the supporting spring system has lifting elements 14 which are designed and operate in the manner of air springs. In the exemplary embodiment shown, each end of each slat 10 is assigned a lifting element 14. As a result, each slat 10 has two lifting elements 14. The lifting elements 14 are all of essentially identical design. It is conceivable for only certain slats 10 to be assigned lifting elements 14 at opposite ends. The remaining slats 10 are then mounted on the bar elements 12 in a manner known from DE 199 45 724 A1.

In the exemplary embodiment of the invention that is shown here, the lifting elements 14 are arranged in regions of the bar elements 12. The lifting elements 14 are situated between adjacent supporting legs 15, 16 of the bar elements 12, namely in longitudinal grooves 17 between the two supporting legs 15 and 16 of the particular bar element 12, which supporting legs run parallel at a distance from each other. For reasons of simplicity, FIG. 1 shows only two lifting elements 14 which are assigned to the opposite ends of a slat 10. However, identical lifting elements 14 are also assigned to the remaining slats 10.

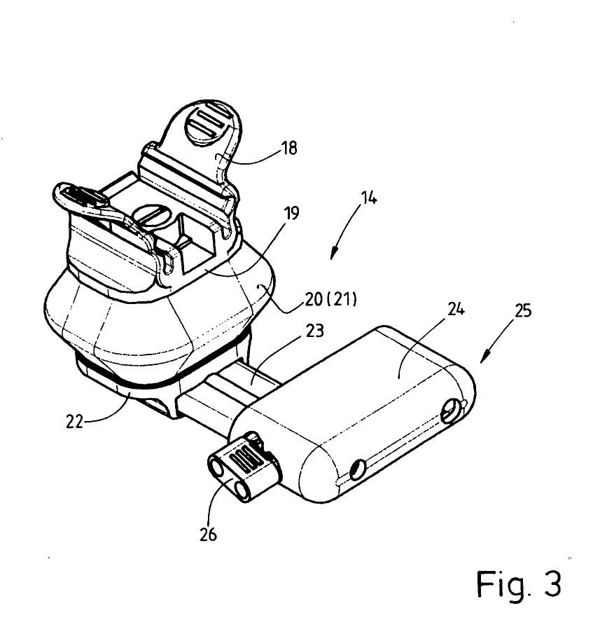

One of the lifting elements 14 of identical design is shown in FIG. 3. The upper side of this lifting element 14 has a clip head 18 which has a rigid, planar head plate 19 on the lower side. The clip head 18 is provided with an upper side of an elastic bellows 20 via the head plate 19. The bellows 20 forms in its interior a cavity 21 which can be acted upon by a fluid, air in the exemplary embodiment shown. On the lower side, the bellows 20 is connected to a base plate 22 with which the lifting element 14 is supported on the bottom of the longitudinal groove 17 of the particular bar element 12 and therefore on or against the longitudinal strut, to which the bar element 12 concerned is assigned. The base plate 22 has an air connection (not shown in FIG. 3) which is connected to an air line which, in the exemplary embodiment shown, is arranged in the interior of a connecting component 23. A free end of the connecting component 23 that protrudes out of the base plate 22 is assigned a valve unit 25 accommodated in a housing 24. The valve unit 25 has a valve (not shown) which can be controlled electrically. The electric control lines (not shown in FIG. 3) can be connected releasably to the valve of the valve unit 25 via a connector 26. The valve unit 25 is also connected to an air line (likewise not shown). It is conceivable to assign two air lines to the valve unit 25, specifically a compressed air line and an outgoing air line.

The electric control lines of the valve units 25 of all of the lifting elements 14 are connected to a common, central controlling means (not illustrated in the figures). Furthermore, at least the compressed-air lines of the valve units 25 of all of the lifting elements 14 are connected to a common air supply device, preferably a pump. In the simplest case, the pump maintains a certain predetermined air pressure in each compressed-air supply line. However, it is also conceivable to control the pump from the central control device and as a result in particular to predetermine the pressure of the pump in accordance with the requirements or else to change it.

The controlling means, which is preferably a programmed controlling means, enables each valve unit 25 to be controlled individually. This makes it possible for each individual lifting element 14 to be individually supplied with compressed air, as a result of which the particular bellows 20 expands upward and therefore raises the clip head 18 of the lifting element 14. Connecting the end of a slat 10 to the particular clip head 18 of the lifting element 14 concerned enables the lifting movement of the bellows 20 to be transferred to the relevant end of a slat 10 which is therefore raised at the end perpendicularly with respect to its longitudinal direction. In order to lower the relevant end of the slat 10, the cavity 21 in the bellows 20 is completely or at least partially vented by the valve unit 25, as a result of which the bellows collapses to the desired extent and the clip head 18 together with the end of the slat 10 that is fastened to it is thereby lowered.

Different lifting movements of the mattress, or preferably of part of the same, are possible by means of appropriate programs of the control unit. In the simplest case, all of the lifting elements 14 are raised and lowered simultaneously (synchronously), as a result of which the entire mattress is moved up and down vertically and the shape of the surface of the mattresses does not change substantially. It is also conceivable, by means of an appropriate controlling means, for only all of the lifting elements 14 on one side of the mattress, i.e. all of the lifting elements 14 assigned to a lateral beam element 12, to be raised or lowered simultaneously while the lifting elements 14 situated on the other side remain unactuated. This results in a sloping position of the mattress or in a tilting of the mattress about the longitudinal direction 11. It is also conceivable to move all of the lifting elements 14 on the one side and at the same time to lower all of the lifting elements 14 on the other side. As a result, the mattress can be tilted about a maximum angle.

Another movement program makes provision to simultaneously raise and lower the slats 10 gradually on both sides in the longitudinal direction 11. For this purpose, the lifting elements 14 assigned to the two opposite sides of a slat 10 are in each case actuated simultaneously. Consecutive raising and/or lowering of the slats 10 in the longitudinal direction 11 of the supporting spring system enables a continuous undulatory movement to be produced on the mattress surface. A further possibility of moving the mattress involves first of all on one side, i.e. along a beam element 12, raising and again lowering the lifting elements individually one after another in the longitudinal direction 11. After the lifting movement along a bar element 12 on one side has taken place, it is continued by the opposite bar element, specifically counter to the longitudinal direction 11. This enables the individual lying on the mattress to experience a type of rotational movement. The above-described types of movement of the mattress and of the individual lying on it can be expanded as desired and so the invention is not restricted to the movement possibilities described above. In particular, any desired combinations of the movements of individual lifting elements 14 are conceivable.

It is also possible, as required, to switch off the automatic controlling means at least temporarily and to control the lifting elements 14 manually. This is preferably undertaken by an individual who is lying on the mattress and who can therefore control and influence the movements in a manner perceived to be the most pleasant. This applies in particular in the case of the supporting spring system according to the invention being used for the treatment of pain. The controlling means can also be used to individually control the lifting distances and/or the raising and lowering speed of the lifting elements 14. It is also conceivable to arrange the lifting elements 14 or air springs having an identical effect as supporting and stimulating elements on the surface of the bed or even to assign them to the bed cover. It is furthermore possible to design the freely programmable controlling means of the lifting elements 14 in such a manner that they permit feedback. To this end, physiological data of the individual laying on the mattress, in particular his movements, are measured and the measured values are used by the controlling means to control the movements of the lifting elements 14 in a specific manner. The measurement for example of the movement of an individual lying on the mattress can take place by a determination of the internal pressure in the bellows 20 or in the air feed line to the bellows 20. The controlling means makes it possible, by means of an appropriate selection of the program, for the lifting elements 14 to move the mattress both periodically and also irregularly, in particular quasi-periodically. It is also possible, in addition to the abovementioned feedback values, for other signals to enter the controlling means, for example acoustic signals, specifically, in particular, music signals. Visual signals, for example color signals, can also be processed by the controlling means as required.

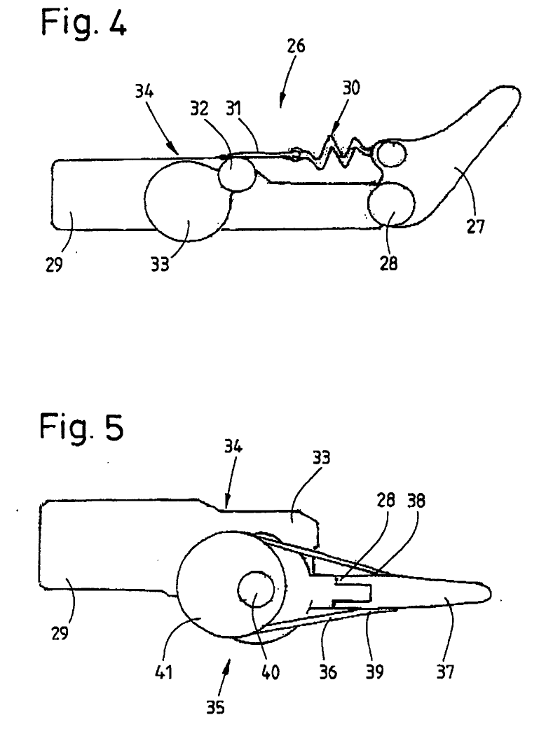

The lifting element 26 shown in FIG. 4, like the lifting element 14, is assigned to each end of a slat 10. The lifting element 26 has a hoist element 27 configured as a pivoted lever. The hoist element 27 can pivot around a pivoting swivel axis 28 from its connection with the end section of a motor housing 29 of the lifting element 26 that encompasses an electric motor. Above the swivel axis 28 the hoist element 27 is connected to an end of an elastic element 30 configured as a spring. The other end of the elastic element 30 is connected via a tension member 31, namely a tension strap or traction cable, to a reel of a winding apparatus whose rotational axis is designated in FIG. 4 with reference number 32. The main winding direction of the elastic element 30, namely the longitudinal center axis of the spring, runs parallel to the direction of pull of the tension member 31. The winding apparatus is connected to the motor of the lifting element 26 by means of a schematically drawn gear mechanism 33. In particular the motor, the gear mechanism 33, the tension member 31 as well as the winding apparatus are part of an adjustment actuator 34 for altering the initial tension of the elastic element 30.

In the oblique orientation of the hoist element 27 shown in FIG. 4, the force of its weight alone induces an initial tension of the elastic element 30 in its main effective direction. The hoist element 27, shown pointing upwards in the illustrated oblique position, abuts the underside of the slat 10, or it can also be attached to the slat 10. A winding of the tension member 31 caused by the motor drive results in a deflection, i.e. in a further, additional pretension of the elastic element 30 from its already slightly pretensioned position. Assuming that the slat 10 abuts the hoist element 27 with a certain degree of counter pressure, the hoist element 27 swivels upwards, thereby lifting the slat 10 upwards usually in a vertical direction. A subsequent uncoiling of the tension member 31 allows the elastic element 30 to swing back from its pretensioned position by virtue of its spring restoring force, which causes the hoist element 27 to swivel downwards and thus lower the slat 10. In the embodiment pursuant to FIG. 4, the main effective direction of the elastic element 30, i.e. the direction in which the restoring force preferably acts, runs advantageously at an angle, namely practically transversely, to the up-and-down movement of the slat 10. The lifting element 26 fulfills in particular two functions: For one, it allows the respective slat 10 to move up and down, particularly in a periodic manner and/or in a movement which proceeds according to a predetermined pattern; and for another, it serves as an elastic suspension for the slat 10. As an alternative, or supplement, to the stimulation movements of the respective slat 10, it is therefore possible to set the suspension of the respective slat 10 to various degrees of stiffness by readjusting the tension of the elastic element 30.

FIG. 5 shows a lifting element 35 which differs from the lifting element 26 shown in FIG. 4, in particular in the adjustment actuator 34 and the elastic element 30. In place of a torsion spring, the lifting element 35 of FIG. 5 is provided with a circulating belt 36, which can be elastically tensile for the purpose of achieving the spring characteristics of the lifting element 35. Two sections 38, 39 of the belt 36 engage above the swivel axis of the hoist element 37 on the left and right, respectively, and are connected to the hoist element 37. The remaining part of the belt 36 is guided around an eccentric 41, which rotates about an axis 40 and is driven by a geared motor unit. Due to the movement of the eccentric 41 about the axis 40, the belt 36, depending on the position of the eccentric 41, is either loaded with an additional pre-tension, i.e. deflected against the spring restoring forces, or conversely, moved out of its pretensioned position, thus allowing the spring restoring forces of the belt 36 to take effect. With additional pre-tension applied to the belt 36, the hoist element 37 is moved upward about the axis 40, i.e. out of the plane of the drawing. When tension on the belt 36 is eased, the hoist element 37 is moved downward, i.e. back into the plane of the drawing.

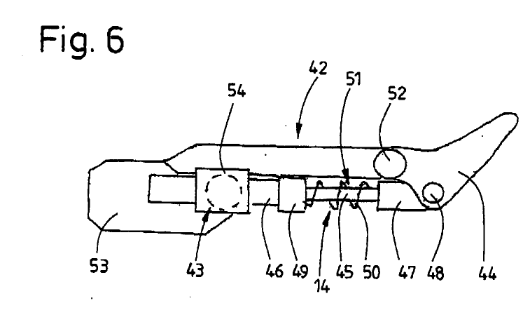

In contrast to the lifting element 14 of FIG. 1, the lifting element 42 of FIG. 6 has a linear actuator 43 as the adjustment actuator for swiveling the hoist element 44. To this end, a rod-like piston element 45 is displaceably guided with an end section in rectilinear fashion within a cylinder element 46 of the linear actuator 43. The other end of the rod-like piston element 45 is connected as a single piece to a flange-like end piece 47, which in turn is pivotally connected to the hoist element 44 about swivel axis 48. On the side facing the hoist element 44, the cylinder element 46 has a cylindrical limit flange 49. Between this limit flange 49 and the flange-like end piece 47, an elastic element configured as a spring 50 encircles the visible section 51 of the rod-like piston element 45, i.e. the section which is not located within the cylinder element 46, along the entire length of said section. The hoist element 44 is pivotally connected, via a further swivel axis 52 arranged above the swivel axis 48, directly to an end section of a motor housing 53 of the lifting element 42.

The cylinder element 46 can be displaced relative to the longitudinal axis of the motor housing 53 by means of a spindle drive 54. By moving the cylinder element 46 in the direction of the hoist element 44, the cylindrical limit flange 49 moves in the direction of the spring 50 relative to the piston element 45 guided within the cylinder element 46 until the restoring force caused by the compression of the spring 50 becomes so great that further movement of the cylinder element 46 results in an upward pivoting of the hoist element 44 about the swivel axis 52.

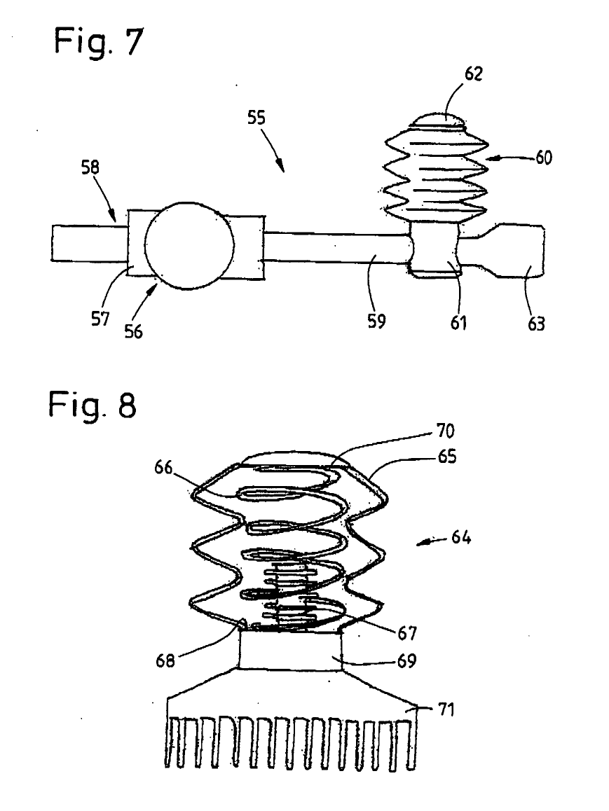

FIG. 7 shows a side view of a further embodiment of a lifting element 55. A motor housing 56 with a gearbox 57 drives via a spindle 58 a piston within a pressure-medium cylinder 59. The fluid medium located in the pressure-medium cylinder 59, which can be either a gas or a liquid, is pressed in a volume-elastic, bellow-like hollow body 60, which is connected to the pressure-medium cylinder 59 by means of a coupler 61. The bellows-like hollow body 60, which in the lifting element 55 acts as a hoist element, has on its top side a bearing header 62, on which the end of the respective slat 10 rests, in particular is mounted. As a result of the corresponding lifting movements of the piston of the pressure-medium cylinder 59, the bellows-like hollow body 60 expands or contracts, which ultimately causes up-and-down movements of the slat 10 resting on the bearing header 62. Should the volume of the bellows-like hollow body 60 not be elastic enough, it can be supplemented by an air reservoir 63 as its spring element.

FIG. 8 shows a cross-sectional view of a different embodiment of a lifting element 64. This lifting element 64 has no motor drive. A lifting element configured as a bellows-like hollow body 65 has as its interior elastic element a spring 66 made from what is known as shape-memory metal, such as a NiTi alloy. As an alternative, a bimetal can be employed. In exemplary embodiment shown in FIG. 8, the spring 66, which assumes a spiral or helical configuration, encircles a heating coil 67. A base 68 of the bellows-like hollow body 65 is formed by a cooling surface of a cooling element 69, namely a Peltier element. The spring 66 extends inside the bellows-like hollow body 65 from the hollow body base 68, i.e. the cooling surface of the cooling element 69, to a hollow body head 70 opposite the hollow body base 68. Connected to the cooling element 69 is another cooling element 71, which however is passive and provided with cooling fins. Reacting to alternating heating and/or cooling, the spring 66 alters its external dimensions, in particular its longitudinal extent. This results in the movement of the hollow body head 70, which is connected to the spring 66, thus causing the end of the respective slat 10 associated with the hollow body head 70 to move up and down.

The supporting spring system according to the invention, in particular the means of controlling the movements of the bed, furniture for lying on or sitting on that are brought about by the supporting spring system serve for stimulation purposes, in particular basal stimulating care of unconscious individuals, individuals on respirators, disorientated individuals, somnolent individuals, individuals with skull and brain trauma, patients with hypoxic brain damage, individuals with Alzheimer's, patients whose mobility is restricted, disabled individuals and/or premature babies. The stimulation may be somatic stimulation, vestibular stimulation, vibratory stimulation, oral stimulation, auditory stimulation, tactile and haptic stimulation, visual stimulation and combinations of the abovementioned types of stimulation. The effect of the stimulation is, in particular, the elimination of a lack of stimulus. The stimulation brought about by specific movement in particular of the mattress serves, in particular, for preventing and/or treating bed sores. In addition, the stimulations also serve to assist in the treatment of pain and/or to promote perception.

The above detailed description of the preferred embodiments, examples, and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A supporting spring system for mattresses or the like, comprising:
a) slats (10) that support the mattress or the like, the slats having opposite ends; and
b) bearing means (12) that are assigned to the opposite ends of the slats (10), the bearing means (12) being for elastically mounting the slats (10) on a frame,
wherein at least some of the slats (10) are movable up and down in a specifically controlled manner.

2. The supporting spring system as claimed in claim 1, wherein at least some of the slats are movable up and down at the ends by means of lifting elements (14) that are operationally attached to the ends.

3. The supporting spring system as claimed in claim 2, wherein the lifting elements are air springs and are located proximal to the bearing means or operationally attached to the bearing means.

4. The supporting spring system as claimed in claim 1, wherein the bearing means comprise hollow bodies (60), the hollow bodies being connected to fluid lines for individually conducting a fluid into and out of the hollow bodies.

5. The supporting spring system as claimed in claim 4, wherein the bearing means further comprise spring elements (30) for elastically mounting the ends of the slats, and the hollow bodies are designed for changing the elasticity of mounting and moving the slats.

6. The supporting spring system as claimed in claim 5, wherein the spring elements of the bearing means are designed to impart a maximum elasticity to the bearing means when the hollow bodies are unpressurized.

7. The supporting spring system as claimed in claim 4, wherein internal pressure in the hollow bodies are controllable via valves (25) actuated by a central controlling means.

8. The supporting spring system as claimed in claim 7, wherein the valves of all of the hollow bodies are feedable from a central fluid pressure source with the fluid such that the fluid feedable to each of the hollow bodies is of the same pressure.

9. The supporting spring system as claimed in claim 4, wherein the hollow bodies are actable upon by different pressures, and the pressure of each of the hollow bodies is changeable individually via at least one of the fluid lines.

10. The supporting spring system as claimed in claim 4, wherein the hollow bodies are expandable independently of one another in at least one direction by means of individual pressurization in such a manner that the hollow bodies individually periodically move the ends of the slats, and exert a lifting movement on the ends of the slats perpendicularly with respect to a longitudinal axis of the slats.

11. The supporting spring system as claimed in claim 4, wherein, a pressure value is assigned to each of the hollow bodies or lifting element to change or maintain the pressures in the hollow bodies for moving the hollow bodies assigned to the lifting elements up and down, the pressure value being actuatable by a control device.

12. The supporting spring system as claimed in claim 11, wherein the control device is designed in such a manner that it actuates each of the hollow bodies or lifting elements independently of one another, whereby a plurality of the hollow bodies or lifting elements are actuatable simultaneously both synchronously and asynchronously.

13. The supporting spring system as claimed in claim 11, wherein the control device is designed for continuously periodically changing the pressures in selected ones of the hollow bodies or in groups of the hollow bodies, the control devices being designed for successively and continuously periodically moving a number of the slats, whereby different slats are movable after one another at different times.

14. The supporting spring system as claimed in claim 2, wherein at least one of the lifting elements has a hoist element (27, 37, 44) assigned to an elastic element (30).

15. The supporting spring system as claimed in claim 14, wherein the elastic element is subjectable to an initial tension.

16. The supporting spring system as claimed in claim 15, wherein the initial tension of the elastic element is continuously variable by means of an adjustment actuator.

17. The supporting spring system as claimed in claim 16, wherein the adjustment actuator has a linear actuator.

18. The supporting spring system as claimed in claim 16, wherein the adjustment actuator has an eccentric.

19. The supporting spring system as claimed in claim 16, wherein the adjustment actuator has a crank assembly.

20. The supporting spring system as claimed in claim 16, wherein the adjustment actuator has a winding apparatus.

21. The supporting spring system as claimed in claim 16, wherein the adjustment actuator has an electromotor drive.

22. The supporting spring system as claimed in claim 16, wherein the adjustment actuator has a hydraulic or pneumatic drive.

23. The supporting spring system as claimed in claim 1.6, wherein the adjustment actuator is configured as a shape-memory actuator.

24. The supporting spring system as claimed in claim 14, wherein the elastic element is configured as a spring.

25. The supporting spring system as claimed in claim 14, wherein the elastic element is configured as an elastic strip.

26. The supporting spring system as claimed in claim 14, wherein the elastic element is configured as a shape-memory spring.

27. The supporting spring system as claimed in claim 26, wherein the shape-memory spring has dimensions that are alterable by alternating heating and cooling, thus causing a movement of the hoist element.

28. The supporting spring system as claimed in claim 14, wherein the at least one of the lifting elements is operatively connected to an electromotor that drives the at least one of the lifting elements.
